(19) United States
(12) Patent Application Publication
(10) Pub. No.: US 2008/0298439 A1
(43) Pub. Date: Dec. 4, 2008

(54) Device and Method for Processing Data by Modulating Sets of Spreading Pseudocodes as a Function of Data Destination Cells for a Multi-Beam Communication Satellite

(75) Inventors: Olivier Courseille, Auzeville (FR); Catherine Dargeou, Cugnaux (FR); Pascal Aubert, Saint Jean (FR); Gerard Raguenet, Eaunes (FR)

Correspondence Address: LOWE HAUPTMAN & BERNER, LLP, 1700 DIAGONAL ROAD, SUITE 300, ALEXANDRIA, VA, 22314, US

(73) Assignee: THALES

(21) Appl. No.: 12/067,604

(22) PCT Filed: Sep. 22, 2006
(86) PCT No.: PCT/FR2006/050932

§ 371 Date: Jul. 23, 2008

(30) Foreign Application Priority Data
Sep. 23, 2005 (FR) 0552837

(51) Int. Cl. H04B 1/707

(52) U.S. Cl. 375/146; 375/E01.002

(57) ABSTRACT

A device (D) is dedicated to the processing of data by spread spectrum coding for a multi-beam communication satellite (S), each beam (B1-B6) of which is associated with a terrestrial cell (C1-C6) contained in a satellite coverage zone (ZC). This device (D) comprises coding means (MC) charged i) with associating, on the one hand, sets of pseudo-spreading codes (J1-J4), differing pairwise, with adjacent cells of the zone (ZC) and with signalling channels common to the collection of cells (C1-C6) of this zone (ZC), and on the other hand, identical sets of pseudo-spreading codes with non-adjacent cells of the zone, the sets (J1-J4) being chosen from among sets resulting from the subdivision of a collection of pseudo-spreading codes, and ii) when data have to be broadcast in a cell (C1) and/or common information data have to be broadcast in the collection of cells, with modulating pseudo-spreading codes belonging to the set (J1) associated with this cell (C1) with the data to be broadcast, then with modulating a carrier, whose frequency (f) is the same for all the beams (B1-B6) of the satellite (S), with the modulated pseudo-spreading codes so that the modulated carrier is broadcast towards the cell (C1) or the collection of cells (C1-C6) by means of the associated beam (B1).

### CROSS-REFERENCE TO RELATED APPLICATIONS

The present Application is based on International Application No. PCT/FR2006/050932, filed on Sep. 22, 2006, which in turn corresponds to French Application No. 0552837 filed on Sep. 23, 2005, and priority is hereby claimed under 35 USC §119 based on these applications. Each of these applications are hereby incorporated by reference in their entirety into the present application.

### FIELD OF THE INVENTION

The invention relates to satellite communication networks, and more precisely devices charged with spread spectrum processing of data with a view to their broadcasting by multi-beam communication satellites belonging to such networks.

### BACKGROUND OF THE INVENTION

Certain satellite networks use a technique termed “spread spectrum coding” to broadcast data by means of multi-beam satellites towards terrestrial cells each associated with a satellite beam. This technique is defined by standards such as IÏS-95 or 3GPP, which bundle together notably CDMA (for “Code Division Multiple Access”), W-CDMA (for “Wide CDMA), CDMA2000 and TD-SCDMA (for “Time Division Synchronous CDMA”), as well as all their variants.

The spread spectrum technique consists, in its basic version (CDMA or WCDMA), in modulating pseudo-spreading codes, generally of Hadamard code type, with data to be broadcast, then in modulating a carrier with these modulated pseudo-spreading codes so that the modulated carrier is broadcast towards the terrestrial cell for which the data are intended by means of a satellite beam dedicated to this cell. The various pseudo-spreading codes are modulated by data intended for different communication terminals (mobile or otherwise), situated in a cell. The modulated pseudo-spreading codes also modulate a scrambling code, and the carrier to be broadcast is modulated with this modulated scrambling code.

As known by the person skilled in the art, in a conventional satellite network, each terrestrial cell (or “spot”) is associated with one of the beams of a satellite, and the various beams are all associated with one and the same collection of mutually quasi-orthogonal pseudo-spreading codes. The beams associated with adjacent cells using either one and the same scrambling code shifted over time, or different scrambling codes, it is therefore indispensable that the frequencies of the carriers broadcast by these beams be different if one wants to avoid a degradation induced by interference due to the lack of orthogonality between cells. Reuse of frequency between adjacent cells being forbidden, each beam can therefore use only a small part of the bandwidth allocated to the system. More precisely, if the configuration of the terrestrial cells compels the use of N different carrier frequencies, each beam of a multi-beam satellite can then use only an N-th portion of the allocated bandwidth. This greatly limits the transmission capabilities, even if these N frequencies can be reused in non-adjacent cells.

### SUMMARY OF THE INVENTION

The aim of the invention is therefore to improve the situation.

It proposes for this purpose a device for processing data by spread spectrum coding, for a communication network comprising at least one multi-beam communication satellite, each beam being associated with a terrestrial cell contained in the whole of the satellite coverage zone.

This processing device is characterized by the fact that it comprises coding means charged:
with associating, on the one hand, sets of pseudo-spreading codes, differing pairwise, with adjacent cells of the coverage zone and with signalling channels common to the collection of cells of the coverage zone, and on the other hand, identical sets of pseudo-spreading codes with non-adjacent cells of this same coverage zone, the sets being chosen from among sets resulting from the subdivision of a collection of pseudo-spreading codes, and
in the event of data to be broadcast in a cell of the coverage zone and/or of common information data to be broadcast in the collection of cells of the coverage zone, with modulating pseudo-spreading codes belonging to the set associated with this cell or with the collection of said cells with said data to be broadcast, then with modulating a carrier, whose frequency is the same for all the beams of the satellite, with the modulated pseudo-spreading codes so that the modulated carrier can be broadcast towards the cell or the collection of cells by means of its associated beam.

The device according to the invention can comprise other characteristics which can be taken separately or in combination, and notably:
its coding means can be charged with modulating a scrambling code, identical for all the cells of the coverage zone, with the modulated pseudo-spreading codes, then with modulating the carrier with this modulated scrambling code so that the modulated carrier can be broadcast towards the cell concerned or the collection of cells by means of its associated beam;
its coding means can be charged with making coherent the sets of pseudo-spreading codes for the data to be broadcast and the common signalling channels, with a view to allowing good reception at any point of the coverage zone.

The invention also proposes a multi-beam communication satellite (for a satellite communication network) equipped with a processing device of the type of that presented above.

The invention also proposes a method for processing data by spread spectrum coding, for a multi-beam communication satellite, consisting:
in associating, on the one hand, sets of pseudo-spreading codes, differing pairwise, with adjacent cells of a zone covered by the beams of the satellite and with signalling channels common to the collection of cells of this covered zone, and on the other hand, identical sets of pseudo-spreading codes with non-adjacent cells of this zone, the sets being chosen from among sets resulting from the subdivision of a collection of pseudo-spreading codes,
in allocating one and the same chosen carrier frequency to each of the beams of the satellite, and
when data have to be broadcast in a cell of the coverage zone and/or common information data have to be broadcast in the collection of cells of the covered zone, in modulating pseudo-spreading codes belonging to the set which is associated with this cell with the data to be broadcast, and in modulating the carrier of chosen frequency with the modulated pseudo-spreading codes so that the modulated carrier is broadcast towards the cell or the collection of cells.

The method according to the invention can comprise other characteristics which can be taken separately or in combination, and notably:
it is possible to modulate a scrambling code, identical for all the cells of the coverage zone, with the modulated pseudo-spreading codes, then modulate the carrier with the modulated scrambling code so that the modulated carrier is broadcast towards the cell concerned or the collection of cells by means of its associated beam;
it is possible to make coherent the sets of pseudo-spreading codes for the data to be broadcast and the common signalling channels, so as to be able to receive at any point of the coverage zone.

The invention is particularly well adapted, although in a non-exclusive manner, to satellite communication networks of the type termed “code division multiple access”, such as those implementing the CDMA, W-CDMA, CDMA2000 and TD-SCDMA techniques, as well as their variants.

The object of the invention is to allow an increase in the transmission capabilities of communication satellites belonging to satellite communication networks using a spread spectrum coding technique.

Other characteristics and advantages of the invention will be apparent on examining the description detailed hereinafter, and the appended drawing, in which the single FIGURE illustrates in a very diagrammatic manner a part of a satellite network comprising a communication satellite, equipped with an exemplary embodiment of a processing device according to the invention, and the associated coverage zone. The appended drawing may not only serve to supplement the invention, but also contribute to its definition, if appropriate.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a diagram of a part of a satellite network including a communication satellite and an associated coverage zone.

### DETAILED DESCRIPTION OF THE INVENTION

In what follows, it is considered by way of non-limiting example that the satellite network uses a spread spectrum coding technique of W-CDMA type to transmit data, via its communication satellites, to mobile communication terminals situated in its terrestrial cells. But, the invention is not limited to this application. It relates indeed to all networks using a technique defined by the IS-95 or 3GPP standards, and notably CDMA, W-CDMA, CDMA2000 and TD-SCDMA, as well as all their variants.

Additionally, the invention does not relate exclusively to mobile (or portable) communication terminals, such as for example mobile telephones, personal digital assistants (or PDAs) and portable computers equipped with a satellite communication module. It also relates to fixed communication terminals equipped with a satellite communication module, notably when the coding technique used is CDMA.

Represented in the single FIGURE is a multi-beam communication satellite S belonging to a satellite network (here of W-CDMA type). This satellite S comprises a transmit/receive module MER charged with generating wavebeams Bi intended to broadcast data destined for (communication) terminals T situated in terrestrial cells (or “spots”) Ci. Each beam Bi of the satellite S is dedicated to a cell Ci. The collection of cells Ci, covered by the beams Bi, constitutes the coverage zone ZC of the satellite S. The module MER also generates a wavebeam BT intended to broadcast signalling channels common to the collection of cells Ci of the coverage zone ZC. These common signalling channels are intended to comprise common information data to be broadcast in the collection of cells Ci of the coverage zone ZC.

In the non-limiting example, illustrated in the single FIGURE, the coverage zone ZC comprises six cells C1 to C6 (i=1 to 6) each associated with one of the six satellite beams B1 to B6. The index i can take any value greater than or equal to 3, by considering at least one reuse between non-adjacent cells.

The invention proposes first of all to subdivide a collection of N mutually quasi-orthogonal pseudo-spreading codes, such as for example Hadamard codes, into a chosen number A of sets of pseudo-spreading codes Jj G=1 to A).

The number A depends on the configuration of the cells Ci with respect to one another, within their coverage zone ZC, as well as pseudo-spreading codes which are necessary for the common signalling channels. It is at least equal to two. In the example illustrated, by using a set J4 for the common signalling channels, four (A=4) sets J1 to J4 (j=1 to 4) suffice given that outside of the third cell C3, no other cell is actually adjacent to more than two other cells, and that the three sets J1 to J3 associated with the adjacent cells can be reused.

For example, the first set J1 comprises the pseudo-spreading codes bearing the numbers 1, 2, . . . , L, the second set J2 comprises the pseudo-spreading codes bearing the numbers L+1, L+2, . . . , M, the third set J3 comprises the pseudo-spreading codes M+1, M+2, . . . , N-K, and the fourth set J4 comprises the pseudo-spreading codes N-K+1, N-K+2, . . . , N. J1, J2, J3 and J4 therefore comprise respectively L, M-L, N-M-K and K pseudo-spreading codes. The set J4 corresponds to the common signalling channels. The N pseudo-spreading codes of the collection all being mutually quasi-orthogonal, the pseudo-spreading codes of each set Jj are therefore also mutually quasi-orthogonal, just like the pseudo-spreading codes belonging to different sets.

According to the invention, each satellite S of the satellite network is equipped with a data processing device (to be transmitted) D comprising a coding module MC charged with associating, on the one hand, sets of pseudo-spreading codes Jj differing pairwise with adjacent cells of the coverage zone ZC, and on the other hand, identical sets of pseudo-spreading codes with non-adjacent cells of this same coverage zone ZC. The coding module MC is also charged with associating a set of pseudo-spreading codes Jj for the common signalling channels, differing from those allocated to the adjacent cells.

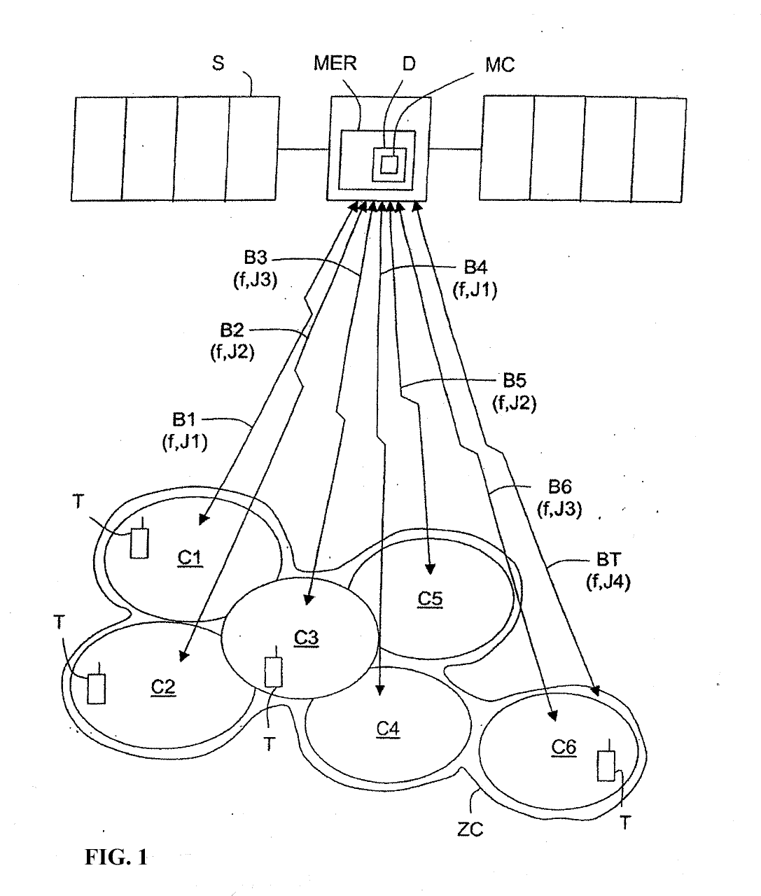

Although represented in FIG. 1 in the satellite S, the data processing device (to be transmitted) D can also be installed in a satellite communication station installed on the ground and transmitting to the satellite S, the latter then merely performing a frequency transposition of the signals arising from the satellite communication station.

In the example illustrated, the third cell C3 is adjacent to the first C1, second C2, fourth C4 and fifth C5 cells, the first C1 and second C2 cells are adjacent, and the fourth cell C4 is adjacent to the fifth C5 and sixth C6 cells. Consequently, the coding module MC can associate:
the set J1 with the first C1 and fourth C4 cells,
the set J2 with the second C2 and fifth C5 cells,
the set J3 with the third C3 and sixth C6 cells, and
the set J4 with the whole of the coverage ZC (for the common signalling channels).

This makes it possible to satisfy the aforesaid conditions for allocating sets between adjacent and non-adjacent cells.

By virtue of such an allocation of sets, the pseudo-spreading codes which are used to transmit data to adjacent cells are always mutually quasi-orthogonal. Consequently, it is henceforth possible to use the same carrier frequency f to transmit data with any one of the beams Bi destined for terminals T situated in any cell Ci, without risk of interference between adjacent beams.

It is important to note that the allocations of the various sets to the various cells Ci (or beams Bi) and to the common signalling channels are preferably determined by the operator of the satellite network, having regard to his knowledge of the cells Ci and of their adjacencies. Consequently, the coding module MC of the device D does nothing other, preferably, than reflect internally the allocations of sets by effecting the corresponding set/cell associations.

Each time that data are to be broadcast in a cell Ci of the coverage zone ZC destined for terminals T situated therein, the coding module MC of the device D intervenes. More precisely, the coding module MC modulates pseudo-spreading codes, which belong to the set Jj which is associated with the cell Ci concerned, with the data to be broadcast. Then, the coding technique used being W-CDMA, the coding module MC modulates a chosen scrambling code with the modulated pseudo-spreading codes.

It is important to note that the scrambling code chosen is the same for all the cells Ci (and therefore all the beams Bi) of one and the same coverage zone ZC. The common signalling channels also using pseudo-spreading codes, they therefore use also the same scrambling code as that which is chosen for the cells Ci.

Thereafter, the coding module MC modulates the carrier, of frequency f (common to all the cells Ci), with the modulated scrambling code, so that the transmit/receive module MER broadcasts the modulated carrier towards the cell Ci concerned by means of its associated beam Bi.

For example, if data are to be broadcast towards terminals T situated in the second C2 and fourth C4 cells, the coding module MC modulates pseudo-spreading codes which belong to the set J2 with the data to be broadcast in the second cell C2, and pseudo-spreading codes which belong to the set J1 with the data to be broadcast in the fourth cell C4. Then, it modulates, on the one hand, the scrambling code of the coverage zone ZC with the modulated pseudo-spreading codes of the set J2, thereby giving a first modulated scrambling code, and on the other hand, the same scrambling code of the coverage zone ZC with the modulated pseudo-spreading codes of the set J1, thereby giving a second modulated scrambling code. Thereafter, the coding module MC modulates, on the one hand, a first carrier, of frequency f, with the first modulated scrambling code, thereby giving a first modulated carrier, and on the other hand, a second identical carrier, of the same frequency f, with the second modulated scrambling code, thereby giving a second modulated carrier. The transmit/receive module MER then broadcasts the first and second modulated carriers towards the second C2 and fourth C4 cells by means of their respectively associated beams B2 and B4.

The coding module MC also carries out a temporal alignment of the collection of pseudo-spreading codes which are used to transmit the data and the common signalling channels to all the cells Ci, so that they remain mutually quasi-orthogonal. More precisely, by considering for example a terminal T in the cell C3, it is preferable that the common signals arising from the beam BT and the signals received in the beam B3 be aligned in relative amplitude, in phase and in delay so as to allow good reception of the data specific to the cell C3. It is also preferable that the residual of the data transmitted by the adjacent beams B1, B2, B4 and B5 and received by the terminal T of the cell C3 exhibit an alignment in phase and in delay with the data specific to the cell C3, so as to minimize the inter-cell interference by guaranteeing the quasi-orthogonality of the pseudo-spreading codes.

For this purpose, the coding module MC takes into account all the imperfections of the transmission chain (relative variations in amplitude, phase and delay), and in particular the specific features of the multi-beam satellite transmission antenna.

The coding module MC comprises the equipment that customarily makes it possible to implement the spread spectrum coding technique, and notably the modulator or modulators, as well as equipment ensuring that all the components of the signal are made coherent by means of detectors and compensators. It may, as illustrated, form part of the transmit/receive module MER. But this is not compulsory. It may indeed, as indicated previously, be located in the satellite communication station making it possible to access the satellite S. In this case, the detectors can be situated in reception stations lying inside the cells Ci.

The processing device D according to the invention, and notably its coding module MC, can be embodied in the form of electronic circuits, software (or computer) modules, or a combination of circuits and software.

A data processing device D making it possible to implement the invention has been described above. But, this invention can also be considered in the form of a data processing method. The latter can be implemented with the aid of the processing device D presented above. The main and optional functions and sub-functions ensured by the steps of this method being substantially identical to those ensured by the various means constituting the device D, only the steps implementing the main functions of the method according to the invention will be summarized hereinafter.

This method consists:
in associating, on the one hand, sets of pseudo-spreading codes Jj, differing pairwise, with adjacent cells Ci of a zone ZC covered by the beams Bi of a satellite S and with signalling channels common to the collection of cells Ci of the covered zone ZC, and on the other hand, identical sets of pseudo-spreading codes Jj with non-adjacent cells Ci of this zone ZC, the sets being chosen from among A sets Jj resulting from the subdivision of a collection of N pseudo-spreading codes,
in allocating one and the same chosen carrier frequency f to each of the beams Bi of the satellite S, and
when data have to be broadcast in a cell Ci of the coverage zone ZC and/or common information data to be broadcast in the collection of cells Ci of this zone ZC, in modulating pseudo-spreading codes belonging to the set Jj which is associated with this cell Ci with the data to be broadcast, and in modulating the carrier of chosen frequency with the modulated pseudo-spreading codes so that the modulated carrier is broadcast towards the cell concerned Ci or the collection of cells Ci. As indicated above, by virtue of the invention, the carrier frequency used (f) is the same in each cell Ci of a coverage zone ZC. Consequently, each satellite beam Bi can use the entirety of the bandwidth allocated to the satellite, thus making it possible to appreciably increase the transmission capability.

The invention is not limited to the embodiments of data processing device, communication satellite and data processing method that were described above, merely by way of example, but it encompasses all the variants that may be envisaged by the person skilled in the art within the framework of the claims hereinafter.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A device for processing data by spread spectrum coding for a communication network, having; at least one multi-beam communication satellite, each beam being associated with a terrestrial cell contained in a satellite coverage zone, comprising:
coding means designed i) to associate, sets of pseudo-spreading codes, differing pairwise, with adjacent cells of said zone and with signalling channels common to the collection of said cells of the zone, identical sets of pseudo-spreading codes with non-adjacent cells of said zone, said sets being chosen from among sets resulting from the subdivision of a collection of pseudo-spreading codes, and ii) in the event of data to be broadcast in a cell and/or of common information data to be broadcast in the collection of said cells of the zone, to modulate pseudo-spreading codes belonging to the set associated with this cell with said data to be broadcast, then to modulate a carrier, whose frequency is the same for all said beams of the satellite, with said modulated pseudo-spreading codes so that the modulated carrier is broadcast towards said cell or the collection of said cells by means of the associated beam.

2. The device as claimed in claim 1, wherein said coding means are designed to modulate a scrambling code, identical for all the cells of said zone, with said modulated pseudo-spreading codes, then to modulate said carrier with said modulated scrambling code so that said modulated carrier is broadcast towards said cell concerned or the collection of said cells by means of the associated beam.

3. The device as claimed in claim 1, wherein said coding means are designed to make coherent said sets of pseudo-spreading codes for the data to be broadcast and for said common signalling channels, with a view to allowing reception at any point of said coverage zone.

4. A multi-beam communication satellite, for a satellite communication network, comprising a data processing device as claimed in claim 1.

5. A satellite communication station, for a satellite communication network, comprising a data processing device as claimed in claim 1.

6. A method for processing data by spread spectrum coding, for a communication network comprising at least one multi-beam communication satellite, each beam being associated with a terrestrial cell contained in a satellite coverage zone, comprising i) in associating, sets of pseudo-spreading codes, differing pairwise, with adjacent cells of said zone and with signalling channels common to the collection of said cells of the zone, and identical sets of pseudo-spreading codes with non-adjacent cells of said zone, said sets being chosen from among sets resulting from the subdivision of a collection of pseudo-spreading codes, ii) in allocating one and the same chosen carrier frequency to each of said beams of the satellite, and iii) in the event of data to be broadcast in a cell and/or of common information data to be broadcast in the collection of said cells of the zone, in modulating pseudo-spreading codes belonging to the set associated with this cell with said data to be broadcast and in modulating said carrier of chosen frequency with said modulated pseudo-spreading codes so that the modulated carrier is broadcast towards said cell or the collection of said cells.

7. The method as claimed in claim 6, wherein iii) a scrambling code, identical for all the cells of said zone, is modulated with said modulated pseudo-spreading codes, then said carrier is modulated with said modulated scrambling code so that said modulated carrier is broadcast towards said cell concerned or the collection of said cells by means of the associated beam.

8. The method as claimed in claim 6, wherein said sets of pseudo-spreading codes for the data to be broadcast and for said common signalling channels are made coherent so as to receive at any point of said coverage zone.

9. A use of the data processing device and of the method for processing data, according to claim 6, in “code division multiple access” satellite communication networks.

10. The use as claimed in claim 9, wherein said networks are chosen from a group comprising at least CDMA, W-CDMA, CDMA2000 and TD-SCDMA.

11. The device as claimed in claim 2, wherein said coding means are designed to make coherent said sets of pseudo-spreading codes for the data to be broadcast and for said common signalling channels, with a view to allowing reception at any point of said coverage zone.

12. A multi-beam communication satellite, for a satellite communication network, comprising a data processing device as claimed in claim 2.

13. A multi-beam communication satellite, for a satellite communication network, comprising a data processing device as claimed in claim 3.

14. A satellite communication station, for a satellite communication network, comprising a data processing device as claimed in claim 2.

15. A satellite communication station, for a satellite communication network, comprising a data processing device as claimed in claim 3.

16. The method as claimed in claim 7, wherein said sets of pseudo-spreading codes for the data to be broadcast and for said common signalling channels are made coherent so as to receive at any point of said coverage zone.
